(19) United States
(12) Patent Application Publication
(10) Pub. No.: US 2023/0281401 A1
(43) Pub. Date: Sep. 7, 2023

(54) COMMUNICATION SYSTEM

(71) Applicants: KABUSHIKI KAISHA TOSHIBA, Tokyo (JP); TOSHIBA DIGITAL SOLUTIONS CORPORATION, Kawasaki-shi, Kanagawa (JP)

(72) Inventors: Atsushi KAKEMURA, Kokubunji, Tokyo (JP); Ryota YOSHIZAWA, Kawasaki, Kanagawa (JP)

(73) Assignees: KABUSHIKI KAISHA TOSHIBA, Tokyo (JP); TOSHIBA DIGITAL SOLUTIONS CORPORATION, Kawasaki-shi, Kanagawa (JP)

(21) Appl. No.: 18/040,662

(22) PCT Filed: Jul. 15, 2021
(86) PCT No.: PCT/JP2021/026570

§ 371 Date: Feb. 6, 2023

(30) Foreign Application Priority Data
Aug. 17, 2020 (JP) 2020-137474

(51) Int. Cl. G06F 40/58; G10L 15/22; G10L 15/26; G10L 13/02

(52) U.S. Cl. CPC G06F 40/58; G10L 15/22; G10L 15/26; G10L 13/02; H04W 4/06

(57) ABSTRACT

A communication system configured to broadcast a voice of utterance of one of users to other users through mobile communication terminals carried by the respective users and to control text delivery such that the result of utterance voice recognition processing on the received utterance voice data is displayed on the mobile communication terminals in synchronization. The communication system is configured to store user-specific language setting information and to produce a translated text through translation of the result of utterance voice recognition into a different language. The broadcast of the utterance voice data includes broadcasting the received utterance voice data to each of the other mobile communication terminals without translation. The text delivery includes delivering the translated text in at least one specified language based on the user-specific language setting information to each of the mobile communication terminals.

### TECHNICAL FIELD

Embodiments of the present invention generally relate to a technique for assisting in communication using voice and text (for sharing of information, conveyance of intention and other purposes), and more particularly, to a multilingual support technique allowing use of multiple languages.

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### PRIOR ART DOCUMENTS

### Patent Documents

[Patent Document 1] Japanese Patent Laid-Open No. 2005-286979

[Patent Document 2] Japanese Patent Laid-Open No. 2020-120357

### DISCLOSURE OF THE INVENTION

### Problems to be Solved by the Invention

It is an object of the present invention to assist in improved quality of information transmission between users using different languages and participating in group calling.

### Means for Solving the Problems

A communication system according to embodiments is configured to broadcast a voice of utterance of one of users to the other users through mobile communication terminals carried by the respective users. The communication system includes a communication control section including a first control section configured to broadcast utterance voice data received from one of the mobile communication terminals to the other mobile communication terminals and a second control section configured to control text delivery such that the result of utterance voice recognition from voice recognition processing on the received utterance voice data is displayed on the mobile communication terminals in synchronization; a storage section configured to store user-specific language setting information; and a text translation section configured to produce a translated text through translation of the result of utterance voice recognition into a different language. The communication control section is configured to broadcast the received utterance voice data to each of the other mobile communication terminals without translation in the first control section and to deliver the translated text in at least one specified language based on the user-specific language setting information to each of the mobile communication terminals in the second control section.

### BRIEF DESCRIPTION OF THE DRAWINGS

FIG. 1 A diagram showing the configuration of a network of a communication system according to Embodiment 1.

FIG. 2 A block diagram showing the configurations of a communication management apparatus and a user terminal according to Embodiment 1.

FIG. 3 A diagram showing exemplary user information and exemplary group information according to Embodiment 1.

FIG. 4 A diagram showing exemplary screens displayed on user terminals according to Embodiment 1.

FIG. 5 A diagram for explaining a multilingual support function (of delivering translated texts) according to Embodiment 1.

FIG. 6 A diagram for explaining a first multilingual support function (function of broadcasting utterance voice and delivering user-specific translated texts) according to Embodiment 1.

FIG. 7 A diagram showing a flow of processing for providing the first multilingual support function according to Embodiment 1.

FIG. 8 A diagram for explaining the first multilingual support function based on a case according to Embodiment 1.

FIG. 9 A diagram for explaining a second multilingual support function (function of broadcasting synthesized voice in multiple languages from an input text and delivering user-specific translated texts) according to Embodiment 1.

FIG. 10 A diagram showing a flow of processing for providing the second multilingual support function according to Embodiment 1.

FIG. 11 A diagram for explaining the second multilingual support function based on a case according to Embodiment 1.

### MODE FOR CARRYING OUT THE INVENTION

### Embodiment 1

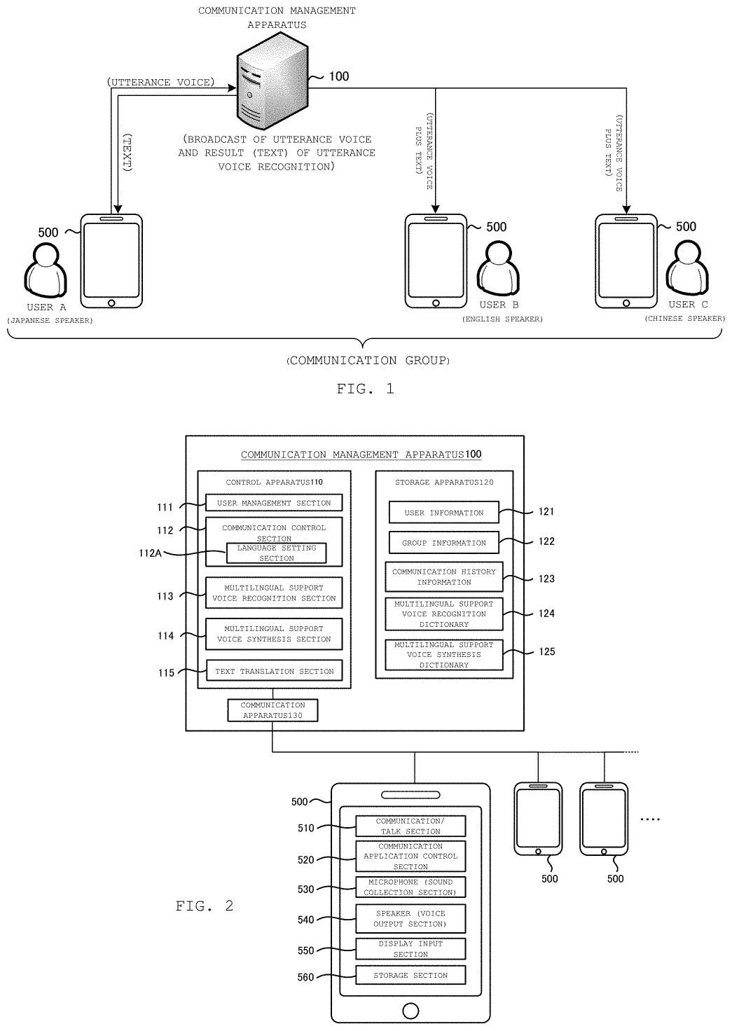

FIGS. 1 to 11 are diagrams for explaining Embodiment 1. FIG. 1 is a diagram showing the configuration of a network of a communication system according to Embodiment 1. The communication system provides an information transmission assistance function with the use of voice and text such that a communication management apparatus (hereinafter referred to as a management apparatus) 100 plays a central role. An aspect of applying the communication system to operation and management of facilities such as accommodations is described below, by way of example.

As shown in FIG. 1, the management apparatus 100 is connected to user terminals (mobile communication terminals) 500 carried by respective users through wireless communication. The management apparatus 100 broadcasts utterance voice data received from one of the user terminals 500 to the other user terminals 500.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

A communication group is set to define the range in which the utterance voice of one of the users can be broadcast to the user terminals 500 of the other users (or the range in which a communication history, later described, can be displayed in synchronization). Each of the user terminals 500 of the relevant users (field users) is registered in the communication group.

The communication system according to Embodiment 1 assists in information transmission for sharing of information, conveyance of intention and other purposes based on the premise that the plurality of users can perform hands-free interaction with each other. Specifically, the communication system according to Embodiment 1 has a multilingual support function of allowing users using different languages to share information or convey their intentions, thereby assisting in improved quality of information transmission between those users using different languages and participating in group calling.

Recently in Japan, more and more workplaces involving group calling have communication groups including both native Japanese speakers (Japanese speakers) who understand Japanese only and non-native Japanese speakers (foreign language speakers) who understand a little Japanese. Communication between the speakers of such groups has difficulties in smooth communication from the viewpoint of language understanding regardless of nationality.

This issue may be addressed by a translation technique allowing translation into a non-Japanese language to provide an environment in which communication can be established between Japanese speakers and foreign language speakers. However, only the translation does not resolve the issue completely. Group communication includes conversations for performing tasks based on group calling, and it is important to guide foreign language speakers with poor Japanese skills to improve Japanese communication in daily work.

Translation from utterance voice data of one language into utterance voice data of another language has issues in accuracy and processing speed. The translation should include converting utterance voice data of one language into text through voice recognition processing, converting the result of voice recognition in text form into a translated text in a desired language, and then performing voice synthesis processing on the translated text to produce synthesized translated voice data. In this manner, the voice recognition processing for multiple languages and the machine translation of the result of voice recognition processing into the translated text are performed in succession, so that a long time is taken to produce the synthesized translated voice data (which means a low processing speed). This hinders the communication of group calling in which the real-time nature is critical. The accuracy of the synthesized translated voice data depends on the accuracy of voice recognition processing and the accuracy of machine translation. Low accuracy in the processing results in incorrect messages due to erroneous conversion or incomprehensible messages with which mutual understanding is difficult. It is thus necessary to introduce techniques of voice recognition and machine translation having high processing accuracy, although this is unrealistic in terms of cost as well as the processing speed described above.

As described above, the translation of utterance voice data into multiple languages to produce synthesized translated voice data requires the advanced technologies and high cost, and thus has a high hurdle to overcome to perform real-time communication during group calling. Particularly, if erroneous synthesized translated voice data is provided, smooth communication is hindered to cause confusion on the work site, reducing the work efficiency. It is necessary to provide a mechanism for achieving mutual understanding in a communication group including both Japanese speakers and foreign language speakers in view of both smooth communication and work efficiency.

To address this, in Embodiment 1, utterance voice data of utterance input to any user terminal 500 during group calling is broadcast in its original utterance language without translation, whereas the result of voice recognition is processed into translated texts in languages specified in language setting information set by users and those texts are provided to the users using the respective languages. This configuration can limit reductions in processing speed and translation accuracy to provide smooth communication in group calling.

While an example of foreign language speakers is non-native Japanese speakers who understand a little Japanese in the above description, the communication system can provide an environment in which smooth communication is improved and facilitated even when the foreign language speakers include non-native Japanese speaker who understand little or no Japanese.

FIG. 2 is a block diagram showing the configurations of the management apparatus 100 and the user terminal 500. In the following description, a translated text produced through translation of the result of voice recognition of utterance voice data (text produced through translation of the result of voice recognition) is referred to as a first translated text, and a translated text produced through translation of an input text of a language into another language (text produced through translation of an input text) is referred to as a second translated text.

The management apparatus 100 includes a control apparatus 110, a storage apparatus 120, and a communication apparatus 130. The communication apparatus 130 manages communication connection and controls data communication with the user terminals 500. The communication apparatus 130 controls broadcast to distribute utterance voice data from one of the users and text information representing the content of the utterance to the user terminals 500 at the same time, thereby providing a communication environment for group calling.

The control apparatus 110 includes a user management section 111, a communication control section 112, a language setting section 112A, a multilingual support voice recognition section 113, a multilingual support voice synthesis section 114, and a text translation section 115. The storage apparatus 120 includes user information 121, group information 122, communication history (communication log) information 123, a multilingual support voice recognition dictionary 124, and a multilingual support voice synthesis dictionary 125.

The multilingual support voice recognition section 113 and the multilingual support voice recognition dictionary 124 provide a voice recognition processing function which supports various languages including Japanese, English, Chinese, Spanish, French, and German by using the voice recognition dictionary appropriate for the language of utterance voice data of each user received from his user terminal 500 to produce the result of voice recognition in the same language as that of the utterance voice data.

The multilingual support voice synthesis section 114 and the multilingual support voice synthesis dictionary 125 provide a voice synthesis function which supports various languages by receiving character information input in text form on each user terminals 500 or character information input in text form on an information input apparatus other than the user terminal 500 (for example, a mobile terminal or a desktop PC operated by a manager, an operator, or an supervisor) and producing synthesized voice data in the language of the received character or a language (language of the second translated text) other than the language of the received character. The synthesized voice data can be produced from any appropriate materials of voice data in associated languages.

The user terminal 500 includes a communication/talk section 510, a communication application control section 520, a microphone 530, a speaker 540, a display input section 550 such as a touch panel, and a storage section 560. The speaker 540 is actually formed of earphones or headphones (wired or wireless).

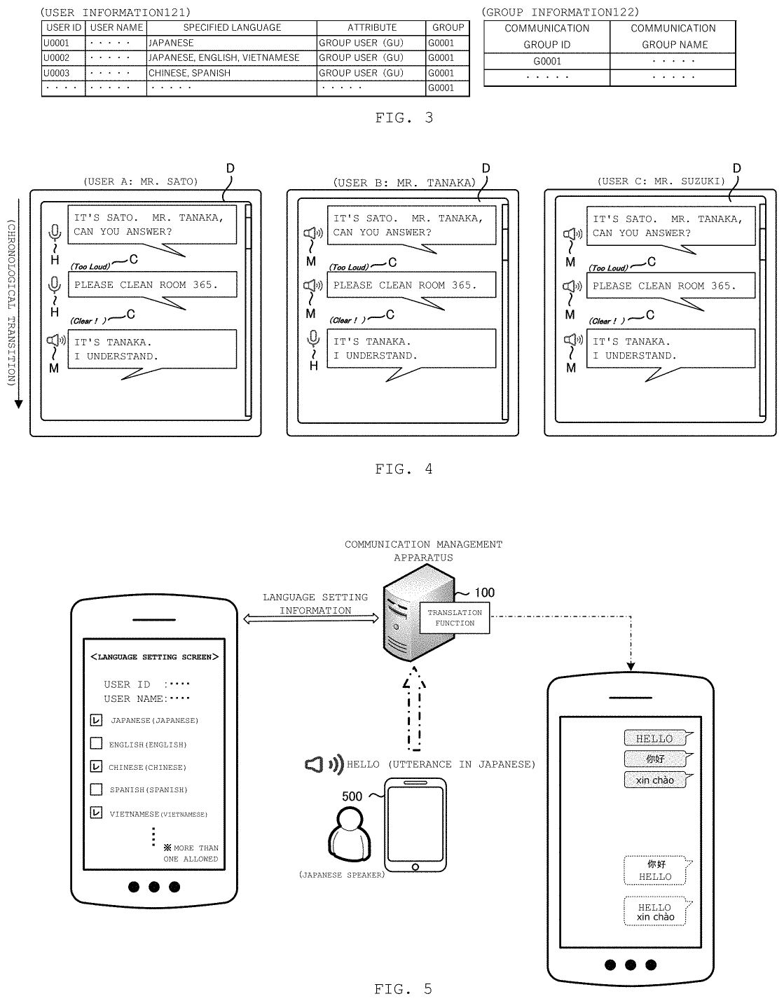

FIG. 3 is a diagram showing examples of various types of information. User information 121 is registered information about users of the communication system. The user management section 111 controls a predetermined management screen to allow setting of a user ID, user name, attribute, and group on that screen. The user management section 111 manages a list of correspondences between a history of log-ins to the communication system on user terminals 500, the IDs of the users who logged in, and identification information of the user terminals 500 of those users (such as MAC address or individual identification information specific to each user terminal 500).

The user information 121 includes an item of “specified language” as user-specific language setting information. As later described, each user can select and set one or more languages on the user terminal 500.

Group information 122 is group identification information representing separated communication groups. The management apparatus 100 controls transmission/reception and broadcast of information for each of the communication groups having respective communication group IDs to prevent mixed information across different communication groups. Each of the users in the user information 121 can be associated with the communication group registered in the group information 122.

The user management section 111 according to Embodiment 1 controls registration of each of the users and provides a function of setting a communication group in which first control described later (broadcast of the utterance voice data and synthesized voice data) and second control (broadcast of the text resulting from the voice recognition of user's utterance, the first translated text, and the second translated text) are performed.

Depending on the particular facility in which the communication system according to Embodiment 1 is installed, the facility can be classified into a plurality of divisions for facility management. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks. For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

The communication control section 112 of the management apparatus 100 serves as control sections including a first control section and a second control section. The first control section controls broadcast of utterance voice data received from one user terminal 500 or synthesized voice data based on the first translated text to the other user terminals 500 (group calling control) . The second control section chronologically accumulates the result of utterance voice recognition from voice recognition processing on the received utterance voice data or the second translated text in the user-to-user communication history 123 and controls text delivery such that the communication history 123 is displayed in synchronization on all the user terminals 500 including the user terminal 500 of the user who performed the utterance.

The function provided by the first control section is broadcast of utterance voice data and synthesized voice data for providing the group calling function. The utterance voice data corresponds to voice data representing user's utterance. The synthesized voice data corresponds to synthesized voice data produced based on text information input to the user terminal 500. The synthesized voice data includes synthesized voice data produced in the language of the input text and synthesized voice data produced in the language of the second translated text resulting from translation of the input text into another language.

The function provided by the second control section is broadcast of the text resulting from the voice recognition of user's utterance, the first translated text produced through translation of the result of voice recognition into another language, and the second translated text produced through translation of the input text into another language. The voices input to the user terminals 500 and the voices reproduced on the user terminals 500 are all converted into text data which is then accumulated chronologically in the communication history 123 and displayed on the user terminals 500 in synchronization. The multilingual support voice recognition section 113 performs voice recognition processing with the multilingual support voice recognition dictionary 124 and outputs text data as the result of utterance voice recognition. The voice recognition processing can be performed by using any of known technologies.

The communication history information 123 is log information including contents of utterance of the users, together with time information, accumulated chronologically on a text basis. Voice data corresponding to each of the texts can be stored as a voice file in a predetermined storage region, and the position of the stored voice file is recorded in the communication history 123, for example. The communication history information 123 is created and accumulated for each communication group.

The communication history information 123 may accumulate all the texts including the result of voice recognition, the first translated text, and the second translated text, that is, all of the result of voice recognition, the input text, and the translated text in each language. Alternatively, the communication history information 123 may accumulate only the result of voice recognition and the input text without accumulating the translated text.

FIG. 4 is a diagram showing an example of the communication history 123 displayed on the user terminals 500. Each of the user terminals 500 receives the communication history 123 from the management apparatus 100 in real time or at a predetermined time, and the display thereof is synchronized among the users. The users can chronologically refer to the communication log.

As shown in the example of FIG. 4, each user terminal 500 chronologically displays the utterance content of the user of that terminal 500 and the utterance contents of the other users in a display field D to share the communication history 123 accumulated in the management apparatus 100 as log information. In the display field D, each text representing user's own utterance may be accompanied by a microphone mark H, and the users other than the utterer may be shown by a speaker mark M instead of the microphone mark H in the display field D.

Embodiment 1 includes, in aspects of text delivery for display in synchronization among a plurality of users, an aspect of synchronized display of a text representing the same content as a result of voice recognition but in a different language. Embodiment 1 also includes, for an input text, an aspect of synchronized display of a text representing the same content as the input text to the user terminal 500 but in a different language. As later described, a plurality of languages can be set as languages to be used. In this case, Embodiment 1 includes an aspect of displaying, together or in combination, a result of voice recognition or an input text and one or more texts representing the same content in the respective specified languages, and includes an aspect of displaying such texts in the respective specified languages other than the language of the result of voice recognition or the input text.

FIG. 5 is a diagram for explaining a multilingual support function (of delivering translated texts) according to Embodiment 1. The user can set one or more languages on a language setting screen shown in FIG. 5. In setting a plurality of languages, priorities may be specified among the specified languages (not shown).

The language setting screen is provided by the language setting section 112A. The communication application control section 520 of the user terminal 500 transmits language setting information indicating one or more languages selected on the language setting screen to the management apparatus 100. The user management section 111 stores the received language setting information for each user as the specified language in the user information 121.

The text translation section 115 is a processing section configured to provide a machine translation function supporting multiple languages. In an example of FIG. 5, when the user says “konnichiwa” in Japanese, the text translation section 115 machine-translates the text “konnichiwa” corresponding to the result of voice recognition into first translated texts in the respective specified languages registered in the user information 121. For example, the text translation section 115 can produce translated texts including “ [symbol] ” in Chinese and “xin chào” in Vietnamese. Of the produced translated texts, one or more translated texts in the languages selected in the user-specific language setting information are delivered to each user terminal 500 by the second control section of the communication control section 112 as shown in FIG. 5. In the example of FIG. 5, the user sets a plurality of languages, and thus the translated texts in Chinese and Vietnamese are delivered together with the result of voice recognition in Japanese. When only one language is selected, one result of voice recognition or one translated text is displayed.

As shown in FIG. 5, the delivered translated texts can be displayed separately in the respective languages, or the texts in Japanese and another language can be displayed together within speech balloons (display blocks) surrounded by dotted lines.

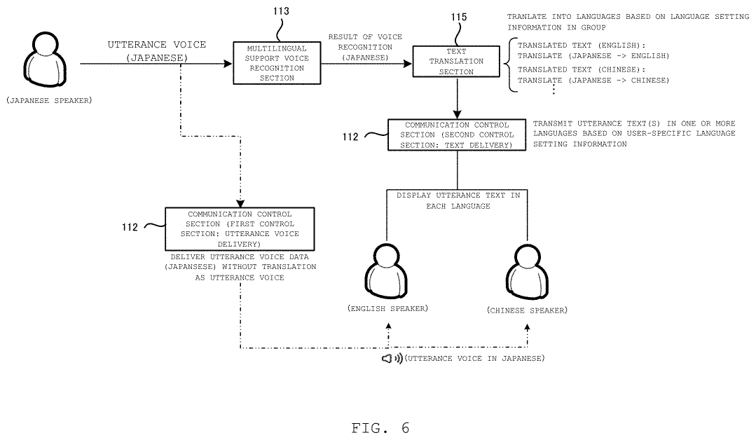

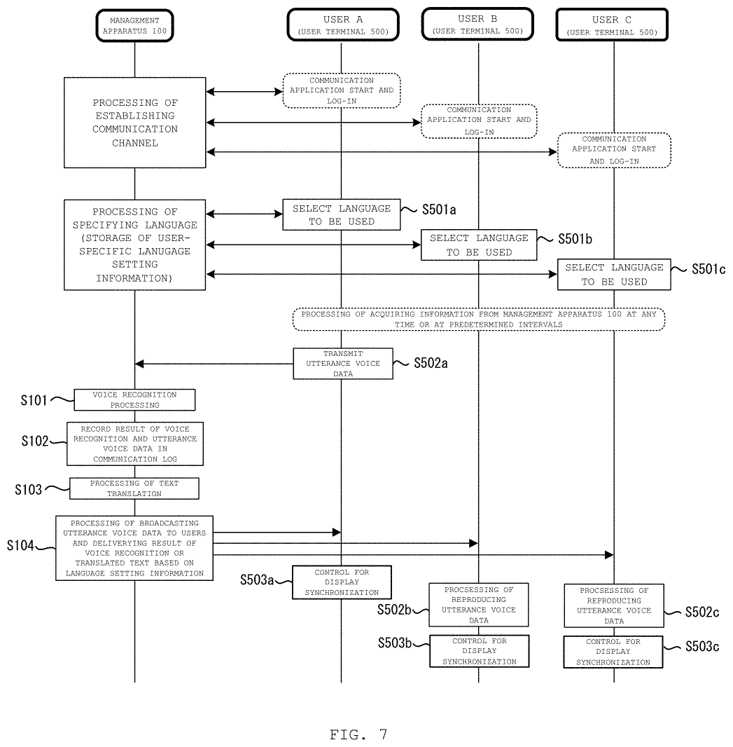

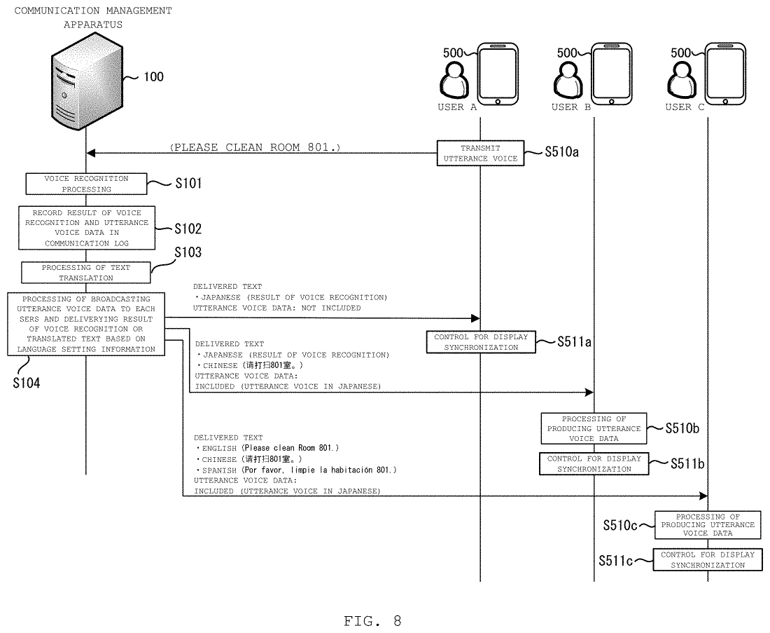

FIG. 6 is a diagram for explaining a first multilingual support function (function of broadcasting utterance voice and delivering user-specific translated texts) according to Embodiment 1.

As shown in FIG. 6, when a Japanese-speaking user performs utterance, the utterance voice data in Japanese is transmitted to the management apparatus 100, and the multilingual support voice recognition section 113 performs voice recognition processing. The result of voice recognition is text information in Japanese. The result of voice recognition is output to the text translation section 115. The text translation section 115 machine-translates the result of voice recognition into one or more languages corresponding to the languages set by the users of the communication group to produce a first translated text in a language other than the language of the result of voice recognition (or a plurality of first translated texts in different languages, if those languages are set).

The first control section of the communication control section 112 broadcasts the received utterance voice data in Japanese to the other user terminals 500 without translation, so that foreign language speakers including any English speaker and Chinese speaker other than the Japanese speaker hear the voice in Japanese from the Japanese speaker. The second control section of the communication control section 112 delivers the translated text(s) in one or more languages to each of the user terminal 500 of the foreign language speakers based on the user-specific language setting information. Each foreign language speaker sees the translated text in the user-specified language displayed on the user terminal 500.

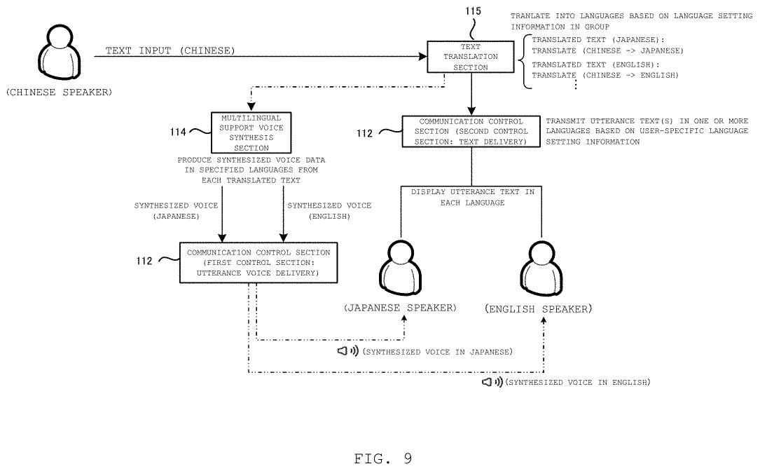

FIG. 7 is a diagram showing a flow of processing performed in the system having the first multilingual support function.

Each of the users starts the communication application control section 520 on his user terminal 500, and the communication application control section 520 performs processing for connection to the management apparatus 100. Each user enters his user ID and password on a predetermined log-in screen to log in to the management apparatus 100. The log-in authentication processing is performed by the user management section 111. At the second and subsequent log-ins, the input operation of the user ID and password can be omitted since the started communication application control section 520 can automatically perform log-in processing with the user ID and password input by the user at the first log-in.

After the log-in, the management apparatus 100 automatically performs processing of establishing a communication channel in a group calling mode with each of the user terminals 500 to open a group calling channel centered around the management apparatus 100.

Each user accesses the management apparatus 100 on the user terminal 500 to set a language to be used (S501a, S501b, S501c). Specifically, the management apparatus 100 transmits the language setting screen to each user terminal 500, receives language setting information (language selection information) from the user terminal 500, and registers the information in the user information 121.

After the log-in, each user terminal 500 performs processing of acquiring information from the management apparatus 100 at any time or at predetermined intervals.

When a Japanese-speaking user A performs utterance, the communication application control section 520 collects the voice of that utterance and transmits the utterance voice data to the management apparatus 100 (S502a) . The multilingual support voice recognition section 113 of the management apparatus 100 performs voice recognition processing on the received utterance voice data (S101) and outputs the result of voice recognition of the utterance content in the form of Japanese text. The communication control section 112 stores the result of voice recognition in the communication history 123 and stores the utterance voice data in the storage section 120 (S102).

The text translation section 115 machine-translates the result of voice recognition in Japanese to produce one or more translated texts (first translated texts) in the language(s) specified in the language setting information set by each user of the communication group (S103).

The communication control section 112 broadcasts the utterance voice data (in Japanese) of the user A, who performed the utterance, to the user terminals 500 of the users other than the user A. The communication control section 112 also transmits the content of the utterance (in Japanese) of the user A stored in the communication history 123 to the user terminals 500 of the users within the communication group including the user A for display synchronization (S104). The communication control section 112 refers to the user-specific language setting information to transmit the translated text(s) in the specified language(s) to the user terminals 500 of each user.

The communication application control sections 520 of the user terminals 500 of the users other than the user A perform automatic reproduction processing on the received utterance voice data (utterance) to output the reproduced utterance voice (S502b, S502c). The user terminals 500 of all the users including the user A display the utterance content of text form corresponding to the output reproduced utterance voice in the display fields D (S502a, S503b, S503c).

FIG. 8 is a diagram for explaining the first multilingual support function based on a case. It should be noted that the same processing operations as those in FIG. 7 are designated with the same reference numbers, and description thereof is omitted.

In the example of FIG. 8, a user A is a Japanese speaker and has set only Japanese in language setting information . A user B is a Chinese speaker and has set Japanese and Chinese in language setting information. A user C is an English speaker and has set English, Chinese, and Spanish in language setting information.

The user A performs utterance in Japanese (S510a), and the utterance voice data thereof is not delivered to the user A but only the result of voice recognition is delivered for display synchronization (S511a) . The Chinese-speaking user B receives the utterance voice data in Japanese of the user A without translation which is then reproduced (S510b) . The user B also receives a translated text in the specified language “Chinese” and the result of voice recognition in the specified language “Japanese” for display synchronization (S511b) . The English-speaking user C receives the utterance voice data in Japanese of the user A without translation which is then reproduced (S510c). The user C also receives a translated text in the specified language “English,” a translated text in the specified language “Chinese,” and a translated text in the specified language “Spanish” for display synchronization (S511c).

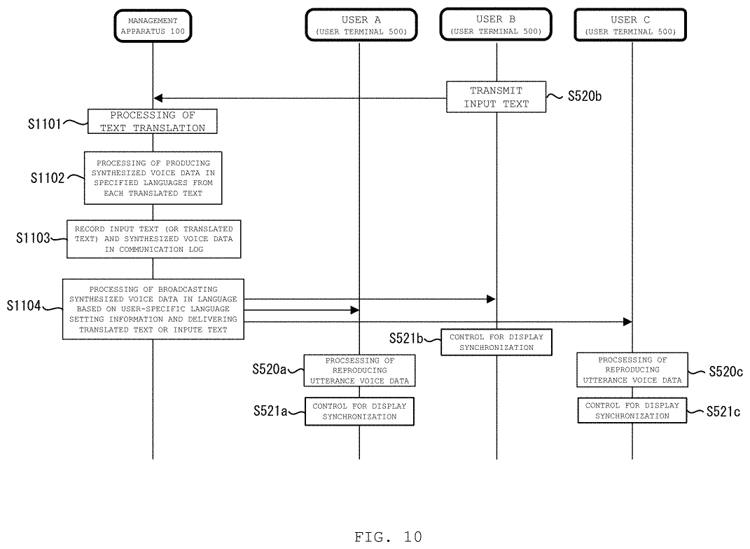

FIG. 9 is a diagram for explaining a second multilingual support function (function of broadcasting synthesized voice in multiple languages based on an input text and delivering user-specific translated texts).

In the example of FIG. 9, the management apparatus 100 receives a text input to the user terminal 500 and provides synthesized voice data from the input text in languages set (easily understood) by the users. Specifically, when a Chinese-speaking user inputs a text in Chinese, the input text in Chinese is transmitted to the management apparatus 100, which then outputs the text to the text translation section 115. The text translation section 115 machine-translates the input text in Chinese into one or more languages corresponding to the languages set by the users of the communication group to produce a second translated text in a language other than Chinese (or a plurality of second translated texts in different languages, if those languages are set).

The second multilingual support function differs from the first multilingual support function described above in that the communication control section 112 performs control to produce synthesized voice data in multiple languages from a text only if text input is performed. The multilingual support voice synthesis section 114 uses the translated text produced from the input text to produce the synthesized voice data in the specified languages. The first control section refers to the user-specific language setting information to provide the user terminals 500 of the users other than the Chinese-speaking user with the synthesized voice data in the languages set by those users. In this case, the users are provided with the synthesized voice data in the languages set by them such that a Japanese-speaking user can hear synthesized voice data in Japanese and an English-speaking user can hear synthesized voice data in English.

The second control section of the communication control section 112 delivers the translated text(s) in one or more languages to each of the user terminals 500 of the users other than the Chinese-speaking user based on the user-specific language setting information. Each of the speakers other than the Chinese-speaking user sees the translated text in the user-specified language displayed on the user terminal 500.

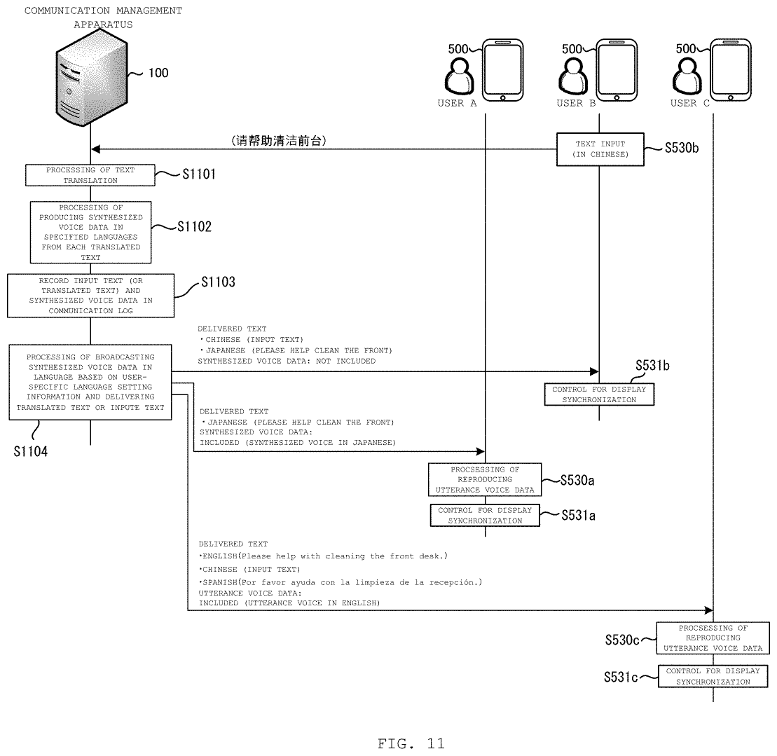

FIG. 10 is a diagram showing a flow of processing performed in the system having the second multilingual support function. The processing operations corresponding to the communication channel establishment and the language setting are omitted to avoid redundant description.

For example, when the Chinese-speaking user B performs text input for group calling, the communication application control section 520 transmits the input text to the management apparatus 100 (S520b). The text translation section 115 of the management apparatus 100 produces one or more translated texts (second translated texts) in the language(s) specified in the language setting information set by each user of the communication group (S1101).

The multilingual support voice synthesis section 114 of the communication control section 112 uses the second translated text output from the text translation section 115 to produce synthesized voice data in the specified languages (S1102). The communication control section 112 stores the input text and other data in the communication history 123 and stores the synthesized voice data in the storage apparatus 120 (S1103).

The communication control section 112 selects the synthesized voice data in the languages corresponding to the user-specific languages set by the users other than the user B, who inputted the text, and broadcasts the selected data to the user terminals 500 of those users. The communication control section 112 also transmits the content of the utterance (in Chinese) of the input text to the user terminals 500 of the users within the communication group including the user B for display synchronization (S1104). The communication control section 112 refers to the user-specific language setting information to transmit the translated text(s) in the specified language(s) to the user terminal 500 of each user.

The communication application control sections 520 of the user terminals 500 of the users other than the user B perform automatic reproduction processing on the received utterance voice data (utterance) to output the reproduced utterance voice (S502a, S502c). The user terminals 500 of all the users including the user B display the utterance content of text form in the specified languages within the display fields D (S521a, S521b, S521c).

FIG. 11 is a diagram for explaining the second multilingual support function based on a case. It should be noted that the same processing operations as those in FIG. 10 are designated with the same reference numbers, and description thereof is omitted.

In the case of FIG. 11, similarly to the example described above, the user A is a Japanese speaker and has set only Japanese in language setting information. The user B is a Chinese speaker and has set Japanese and Chinese in language setting information. The user C is an English speaker and has set English, Chinese, and Spanish in language setting information.

The user B, who is a non-native Japanese speaker, inputs a message of text form for group calling in a main language or Chinese (S530b). Synthesized voice data from the text is not transmitted to the user B who performed the text input, but texts in languages corresponding to the languages set by the user B are transmitted to the user B for display synchronization (S531b). In the example of FIG. 11, the text in Chinese input by the user B and a translated text in Japanese are displayed.

The Japanese-speaking user A receives synthesized voice data translated in Japanese which is then reproduced in Japanese (S530a). The user A also receives a translated text in the specified language “Japanese” for display synchronization (S531b). The English-speaking user C receives synthesized voice data translated in English which is then reproduced in English (S530c). The user C also receives a translated text in the specified language “English,” the input text in the specified language “Chinese,” and a translated text in the specified language “Spanish” for display synchronization (S531c).

As described above, the communication system has the first multilingual support function and the second multilingual support function to provide an environment in which smooth communication in group calling can be achieved with limited reductions in processing speed and translation accuracy.

For example, a non-native Japanese speaker may understand Japanese but have difficulty in Japanese pronunciation. In this case, the first multilingual support function can provide a translated text in a language which is easily understood by such a non-native Japanese speaker, thereby assisting in conveyance of intention. The second multilingual support function can allow smooth group calling through the use of text input instead of utterance. While the example in FIGS. 9 to 11 is described in the aspect in which the non-native Japanese speaker inputs the text in the language other than Japanese, a non-native Japanese speaker can input a text in Japanese. Specifically, non-native Japanese speakers may have difficulties in Japanese pronunciation but understand some Japanese texts. In this case, such non-native speakers can input texts in Japanese to perform smooth communication in group calling even when they have difficulties in Japanese pronunciation.

Non-native Japanese speakers may understand Japanese but have difficulties in listening to Japanese or can understand Japanese texts more than Japanese conversations. In this case, the first multilingual support function and the second multilingual support function of the communication system can provide an environment in which smooth communication can be achieved in group calling.

As described above, either the first multilingual support function or the second multilingual support function of the communication system can provide an environment in which smooth communication can be achieved in group calling.

The system having the first multilingual support function is the communication system in which the plurality of users carry their respective user terminals 500 and a voice of utterance of one of the users input to his user terminal is broadcast to the user terminals 500 of the other users, wherein the communication control section 112 includes the first control section configured to broadcast utterance voice data received from one of the user terminals 500 to the other user terminals 500 and the second control section configured to control text delivery such that the result of utterance voice recognition from voice recognition processing on the received utterance voice data is displayed on the user terminals 500 in synchronization.

The communication system further includes the storage section configured to store the user-specific language setting information, and the text translation section 115 configured to produce the translated text through translation of the result of utterance voice recognition into the different language.

The communication control section 112 is configured to broadcast the received utterance voice data to each of the other mobile communication terminals without translation in the first control section and to deliver the translated text in at least one specified language based on the user-specific language setting information to each of the mobile communication terminals in the second control section.

The system having the second multilingual support function is the communication system in which the plurality of users carry their respective user terminals 500 and a voice of utterance of one of the users input to his user terminal is broadcast to the user terminals 500 of the other users, wherein the communication control section 112 includes the first control section configured to broadcast utterance voice data received from one of the user terminals 500 to the other user terminals 500 and the second control section configured to control text delivery such that the result of utterance voice recognition from voice recognition processing on the received utterance voice data is displayed on the user terminals 500 in synchronization.

The communication system further includes the storage section configured to store the user-specific language setting information, and the text translation section 115 configured to produce the translated text through translation of the result of utterance voice recognition into the different language.

The text translation section 115 is configured to produce the translated text through translation of the input text received from one of the user terminals 500 into the different language based on the user-specific language setting information, and the multilingual support voice synthesis section 114 is configured to use the translated text produced from the input text to produce the synthesized voice data in the specified language.

The communication control section is configured to deliver the synthesized utterance voice data in each of the one or more languages to each of the other user terminals 500 based on the user-specific language setting information in the first control section and to deliver the translated text to each of the user terminals 500 based on the user-specific language setting information in the second control section, the translated text being produced through translation of the input text into each of the one or more languages.

Embodiment 1 of the present invention has been described. The functions of the communication management apparatus 100 and the user terminals 500 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a floppy disk® and removable hard disk, and memory cards such as a compact flash®, smart media, SD memory card, and memory stick. Hardware apparatuses such as an integrated circuit (such as an IC chip) designed and configured specifically for the purpose of the present invention are included in the recording medium.

While an exemplary embodiment of the present invention has been described above, the embodiment is only illustrative and is not intended to limit the scope of the present invention. The novel embodiment can be implemented in other forms, and various omissions, substitutions, and modifications can be made thereto without departing from the spirit or scope of the present invention. These embodiment and variations are encompassed within the spirit or scope of the present invention and within the invention set forth in the claims and the equivalents thereof.

### DESCRIPTION OF THE REFERENCE NUMERALS

100 COMMUNICATION MANAGEMENT APPARATUS
110 CONTROL APPARATUS
111 USER MANAGEMENT SECTION
112 COMMUNICATION CONTROL SECTION (FIRST CONTROL SECTION, SECOND CONTROL SECTION)
112A LANGUAGE SETTING SECTION
113 MULTILINGUAL SUPPORT VOICE RECOGNITION SECTION
114 MULTILINGUAL SUPPORT VOICE SYNTHESIS SECTION
115 TEXT TRANSLATION SECTION
120 STORAGE APPARATUS
121 USER INFORMATION
122 GROUP INFORMATION
123 COMMUNICATION HISTORY INFORMATION
124 MULTILINGUAL SUPPORT VOICE RECOGNITION DICTIONARY
125 MULTILINGUAL SUPPORT VOICE SYNTHESIS DICTIONARY
130 COMMUNICATION APPARATUS
500 USER TERMINAL (MOBILE COMMUNICATION TERMINAL)
510 COMMUNICATION/TALK SECTION
520 COMMUNICATION APPLICATION CONTROL SECTION
530 MICROPHONE (SOUND COLLECTION SECTION)
540 SPEAKER (VOICE OUTPUT SECTION)
550 DISPLAY INPUT SECTION
560 STORAGE SECTION
D DISPLAY FIELD

1. A communication system in which a plurality of users carry their respective mobile communication terminals and a voice of utterance of one of the users input to his mobile communication terminal is broadcast to the mobile communication terminals of the other users, comprising:
a communication control section including a first control section configured to broadcast utterance voice data received from one of the mobile communication terminals to the other mobile communication terminals and a second control section configured to control text delivery such that a result of utterance voice recognition from voice recognition processing on the received utterance voice data is displayed on the mobile communication terminals in synchronization;
a storage section configured to store user-specific language setting information; and
a text translation section configured to produce a translated text through translation of the result of utterance voice recognition into a different language,
wherein the communication control section is configured to:
broadcast the received utterance voice data to each of the other mobile communication terminals without translation, in the first control section; and
deliver the translated text in at least one specified language based on the user-specific language setting information to each of the mobile communication terminals, in the second control section.

2. The communication system according to claim 1, wherein the text translation section is configured to produce the translated text through translation of an input text received from one of the mobile communication terminals into a different language based on the user-specific language setting information,
the communication system further comprising a voice synthesis section configured to use the translated text produced from the input text to produce synthesized voice data in specified languages,
wherein the communication control section is configured to:
deliver the synthesized utterance voice data in one of the specified languages based on the user-specific language setting information to each of the other mobile communication terminals, in the first control section; and
deliver the translated text to each of the mobile communication terminals, the translated text being produced through translation of the input text into at least one of the specified languages based on the user-specific language setting information, in the second control section.

3. The communication system according to claim 1, wherein the communication control section includes a language setting section configured to receive the user-specific language setting information input to each of the mobile communication terminals,
wherein the language setting section is configured to perform control to allow setting of one or more languages per user, and
the communication control section is configured to, when a plurality of language are set in the language setting information input to one of the mobile communication terminals, deliver the translated text in each of the plurality of languages to the mobile communication terminal in the second control section.

4. The communication system according to claim 1, wherein the communication control section is configured to deliver an utterance text including the translated text in a specified language based on the user-specific language setting information and the result of voice recognition to each of the mobile communication terminals and perform control such that the result of voice recognition in a language of the broadcast utterance voice data and the translated text are displayed together in the second control section.

5. A non-transitory computer readable medium including a computer executable program comprising instructions executable by a management apparatus connected to mobile communication terminals carried by their respective users, the management apparatus being configured to broadcast a voice of utterance of one of the users input to his mobile communication terminal to the mobile communication terminals of the other users, wherein the instructions, when executed by the management apparatus, cause the management apparatus to provide:
a first function of broadcasting utterance voice data received from one of the mobile communication terminals to the other mobile communication terminals;
a second function of controlling text delivery such that a result of utterance voice recognition from voice recognition processing on the received utterance voice data is displayed on the mobile communication terminals in synchronization;
a third function of storing user-specific language setting information; and
a fourth function of producing a translated text through translation of the result of utterance voice recognition into a different language,
wherein the first function includes broadcasting the received utterance voice data to each of the other mobile communication terminals without translation, and
the second function includes delivering the translated text in at least one specified language based on the user-specific language setting information to each of the mobile communication terminals.
